(19) United States
(12) Patent Application Publication
(10) Pub. No.: US 2025/0373561 A1
(43) Pub. Date: Dec. 4, 2025

(54) LOSS RECOVERY FOR MULTI-PATH RELIABLE TRANSPORT

(71) Applicant: Advanced Micro Devices, Inc., Santa Clara, CA (US)

(72) Inventors: Yanfang LE, Santa Clara, CA (US); Peter NEWMAN, Santa Clara, CA (US); Rong PAN, Santa Clara, CA (US); Vipin JAIN, Santa Clara, CA (US)

(21) Appl. No.: 18/680,993

(22) Filed: May 31, 2024

(51) Int. Cl. H04L 47/27; H04L 47/11

(52) U.S. Cl. CPC H04L 47/27; H04L 47/11

(57) ABSTRACT

Embodiments herein describe tracking the number of out of order packets that have been received at a receiver (RX) from a particular transmitter (TX). In one embodiment, the RX maintains a packet tracking bitmap that starts with the expected packet sequence number (EPSN) which is the next (sequential) PSN that should be received at the RX. The RX can use acknowledgement packets to transmit the bitmap to the TX so it knows which OOO packets have been received at the RX. However, the bitmap may be too large to fit into one ACK the entire bitmap, which means segments of the bitmap may be transmitted to the TX using multiple ACKs. As such, in the embodiments herein, the RX can also include a total count of the received OOO packets in each ACK.

### TECHNICAL FIELD

Examples of the present disclosure generally relate to determining when to retransmit packets when using multipathing.

### BACKGROUND

Multipathing is one way to improve the fabric bisectional bandwidth utilization. By sending traffic for a given flow to more than one paths in the network, the number of collision points is reduced resulting in higher fabric bandwidth utilization. Path selection is typically done using multiple sessions (e.g. TCP session), or using UDP entropy (src-port). However, there can be congestion on the various paths used to communicate between two endpoints in a network (e.g., two smart network interface cards/controllers (SmartNICs)).

Packet drops are a frequent occurrence in networks, even with advanced switch features such as trimming or back to send (BTS). Silent packet drops can still happen as trimming or BTS cannot guarantee every trimmed packets get acknowledged reliably. Detecting packet drops or loss is harder with multipathing since packets can be received out-of-order at the receiver.

### SUMMARY

One embodiment described herein is a transmitter that includes circuitry configured to transmit packets to a receiver using multipathing and according to a congestion window, receive at least one acknowledgement (ACK) from the receiver, the ACK comprising an out-of-order (OOO) packet count indicating a number of OOO packets that the receiver has received from the transmitter, and upon determining the OOO packet count satisfies a threshold, retransmit one or more packets to the receiver where the threshold is dynamically adjusted based on the congestion window.

One embodiment described herein is a method includes transmitting packets from a transmitter to a receiver using multipathing and according to a congestion window, receiving at the transmitter at least one acknowledgement (ACK) from the receiver, the ACK comprising an out-of-order (OOO) packet count indicating a number of OOO packets that the receiver has received from the transmitter, and upon determining the OOO packet count satisfies a threshold, retransmitting one or more packets from the transmitter to the receiver where the threshold is dynamically adjusted based on the congestion window.

One embodiment described herein is a receiver that includes circuitry configured to receive packets from a transmitter using multipathing, track out-of-order (OOO) packets that are received at the receiver before receiving a next expected packet according to a sequence of packet sequence numbers (PSNs), and transmit at least one acknowledgement (ACK) to the transmitter where the ACK includes an OOO packet count indicating a number of OOO packets that the receiver has received from the transmitter.

One embodiment described herein is a system that includes a receiver and a transmitter configured to transmit packets to the receiver, over a network, using multipathing and according to a congestion window. The receiver is configured to transmit at least one acknowledgement (ACK) to the transmitter, the ACK including an out-of-order (OOO) packet count indicating a number of OOO packets that the receiver has received from the transmitter. The transmitter is configured to, upon determining the OOO packet count satisfies a threshold, retransmit one or more packets to the receiver where the threshold is dynamically adjusted based on the congestion window.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a block diagram of a communication system that uses multi-path routing, according to an example.

FIG. 2 illustrates a packet tracking bitmap, according to an example.

FIG. 3 illustrates transmitting an acknowledgement from a receiver to a transmitter, according to an example.

FIG. 4 is a flowchart for detecting packet loss, according to an example.

FIG. 5 is a flowchart for retransmitting lost packets, according to an example.

FIG. 6 illustrates a data processing unit, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe tracking the number of out of order (OOO) packets that have been received at a receiver (RX) from a particular transmitter (TX). In one embodiment, the RX maintains a packet tracking bitmap that starts with the expected packet sequence number (EPSN) which is the next (sequential) PSN that should be received at the RX. For example, the receiver may have received every packet with a PSN lower than the EPSN. However, because of multipathing, one or more other packets with later PSNs than the EPSN may have already arrived at the RX, which are referred to as OOO packets. The RX can use the bitmap to track the OOO packets.

The RX can use acknowledgement packets (e.g., selective acknowledgements (SACKs) or negative acknowledgements (NACKs) to transmit the bitmap to the TX so it knows which OOO packets have been received at the RX. However, the bitmap may be too large to fit into one ACK, which means segments of the bitmap may be transmitted to the TX using multiple ACKs. As such, in the embodiments herein, the RX can also include a total count of the received OOO packets in each ACK. Thus, even if the TX receives a subportion of the bitmap in an ACK, the ACK still has the total number of OOO packets received at the RX (although the TX might not know the PSNs for those packets).

The TX can use the total number of OOO packets to infer silent packet loss and perform recovery. In one embodiment, the total number of OOO packets is compared to a threshold based on a congestion window used by the TX when transmitting packets to the RX. If the total number of OOO packets meets (or exceeds) the threshold, the TX can infer there is packet loss and begin to retransmit packets. In this manner, the threshold provides a dynamic metric as the congestion window changes to compare to the number of OOO packets to infer packet loss and begin recovery.

Moreover, the TX can use the segments of the bitmap received in the ACKs to determine which packets should be retransmitted. That is, the TX can use the bitmap to identify the OOO packets that have been received and retransmit only the packets that have not been received by the RX. Further, the TX can identify a highest PSN (HPSN) in the bitmap which indicates the OOO packet with the highest PSN that has been received at the RX. The TX may not retransmit any packets that have PSNs higher than the HPSN.

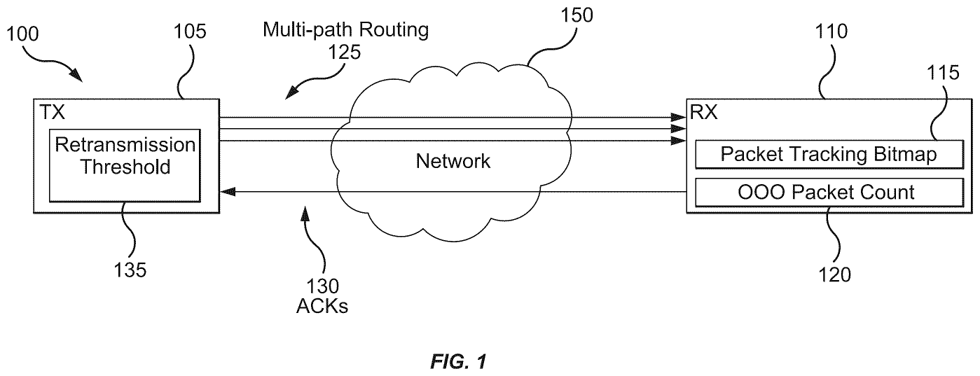

FIG. 1 illustrates a block diagram of a communication system 100 that uses multi-path routing 125, according to an example. The system 100 includes a TX 105 that transmits packets to a RX 110 through a network 150 that supports multi-path routing 125. That is, the packets may take different paths through the network 150 in order to reach the RX 110. These paths may include a different subset of the network devices (e.g., switches and routers) in the network 150.

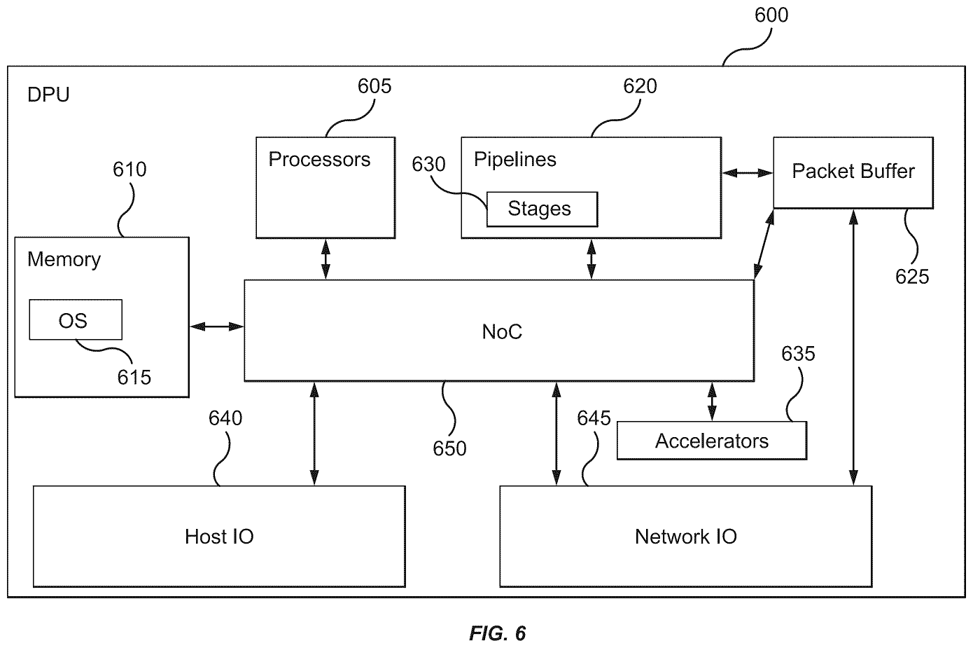

The TX 105 and the RX 110 can be computing devices (e.g., hosts), computing systems, network interface cards/controllers (NICs), SmartNICs, data processing units (DPUs), and the like. FIG. 6 illustrates various embodiments of using a DPU to implement the TX 105 and/or the RX 110.

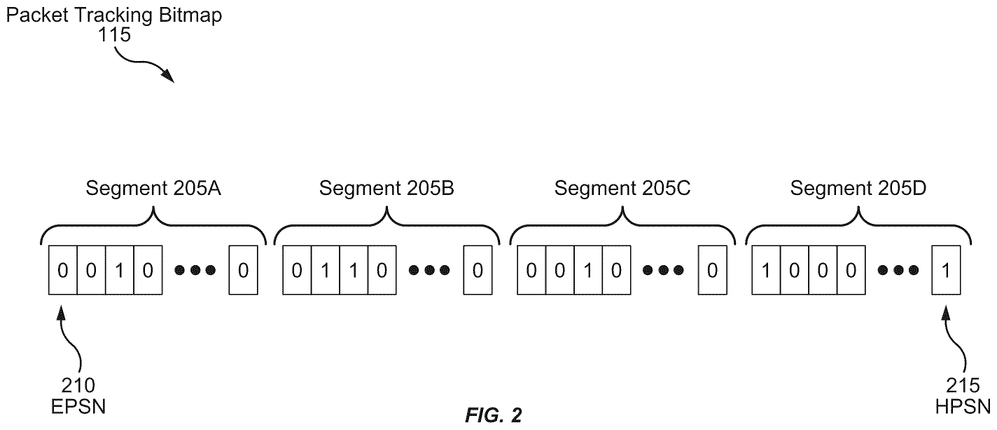

The RX 110 generates a packet tracking bitmap 115 which is a data structure that indicates which packets have or have not been received from the TX 105 using a PSN in each packet. One implementation of the bitmap 115 is discussed in FIG. 2 below, but in general the bitmap 115 can indicate the OOO packets that have been received at the RX. These OOO packets are received “early” at the RX 110. That is, the OOO packets were received before the next expected packet was received at the RX 110—i.e., the EPSN.

The RX 110 also stores a OOO packet count 120. This count can be the total number of OOO packets that have arrived at the RX 110. For instance, when another OOO packet arrives (e.g., a packet with a PSN higher than the EPSN), the RX 110 increments that OOO packet count 120. As the next expected packets arrive, packets that were once considered OOO packets may instead be categorized as expected packets. In that case, the RX 110 can decrement the OOO packet count 120. As such, the OOO packet count 120 can fluctuate up and down as the EPSN and additional OOO packets arrive at the RX 110.

The RX 110 transmits ACKs 130 to the TX 105 to inform the TX 105 which packets (according to their EPSN and bitmaps) have been received at the RX 110. In one embodiments, the ACKs 130 are SACKs, but can also be NACKs.

In one embodiment, the ACKs 130 include at least a portion of the bitmap 115 so that the TX 105 knows which OOO packets have been received at the RX 110. However, the bitmap 115 may be too large to fit into one ACK 130. As such, the bitmap 115 may be divided into segments that are transmitted in different ACKs 130 to the TX 105. This is discussed in more detail in FIG. 2.

In addition to containing data from the bitmap 115, the ACKs 130 can also include the OOO packet count 120. Thus, even if the TX 105 receives only a portion of the bitmap 115 in an ACK 130, the ACK 130 still has the total number of OOO packets (although it might not have the PSN for those packets). The TX 105 can use the OOO packet count 120 to determine (e.g., infer) whether there has been packet loss.

In one embodiment, to infer when there is packet loss, the TX 105 compares the OOO packet count 120 to a retransmission threshold 135. With multipathing, it is expected that there will be OOO packets received at the RX. Thus, receiving OOO packets does not necessary imply there is packet loss. If the retransmission threshold 135 is too small, then what was normal multipathing behavior (where there are some number of OOO packets) can be mistakenly inferred as packet loss. This could trigger spurious retransmission thereby wasting bandwidth. However, if the threshold 135 is too large, then retransmission is triggered too late, resulting in much longer flow completion times (FCTs).

In one embodiment, the retransmission threshold 135 used by the TX 105 is based on the current congestion window used by the TX 105 to transmit packets to the RX 110. The congestion window can be dynamically adjusted using a congestion control algorithm. For example, the congestion window may be set based on round trip time or how much data the TX 105 can successfully send to the RX 110. The congestion control algorithm may increase the congestion window when there is less congestion in the network, but shrink the congestion window if congestion is detected. However, the embodiments herein are not limited to any particular type of congestion control algorithm, and can be used with any suitable algorithm that adjusts a congestion window based on network conditions.

The congestion window determines how many packets the TX 105 can send on the available paths through the network 150. More paths with less congestion can mean a larger congestion window can be used. However, if the paths are reduced and/or congestion increases, the congestion window may be shrunk so that the TX 105 can send fewer packets. As an example, the congestion window limits the number of unacknowledged packets which can implicitly limit a time frame that the TX has to transmit packets based on round-trip time.

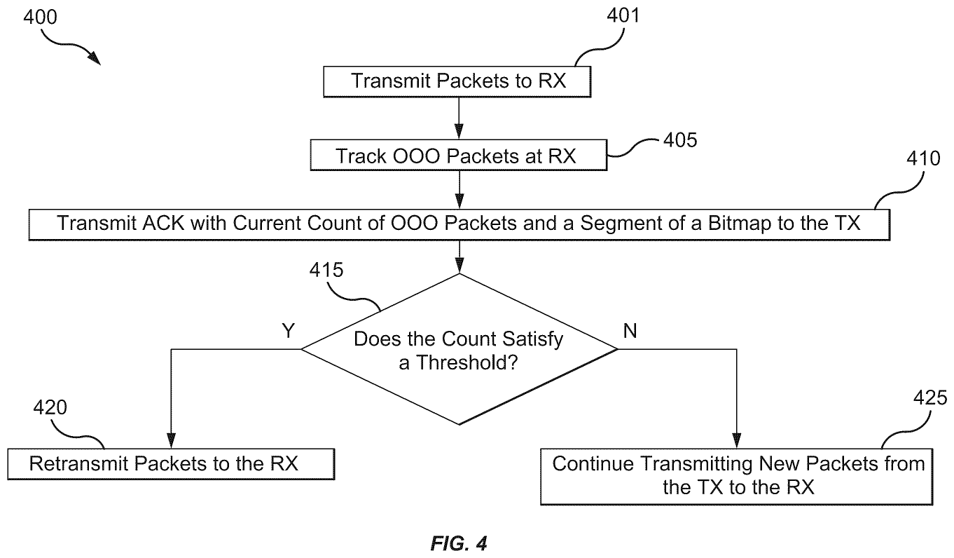

The threshold 135 that is compared to the OOO packet count 120 can change as the congestion window changes. For example, as the congestion window increases, the threshold 135 also increases. As such, there would have to be more OOO packets in order for packet loss to be inferred. However, if the congestion window decreases, the threshold 135 also decreases and fewer OOO packets can trigger retransmission. This is discussed in more detail in FIG. 4.

FIG. 2 illustrates a packet tracking bitmap 115, according to an example. The bitmap 115 is divided into segments 205A-D, but can have any number of segments. In one embodiment, the size (and number) of the segments 205 is dependent on the size of the bitmap 115 and the amount of available space in the ACK (e.g., ACKs 130 in FIG. 1) to carry the segments 205. In one embodiment, each ACK includes one segment 205.

In this example, the bitmap 115 is defined by a EPSN 210 which is the next expected packet. That is, the RX has received all the packets that have PSNs lower than the EPSN 210. Thus, if the RX receives the packet corresponding to the EPSN 210, the EPSN of the bitmap 115 would move to the next bit (assuming the packet with that PSN has not already been received). As such, the EPSN 210 serves as the head or beginning of the bitmap 115. Thus, any bits corresponding to PSNs lower than the EPSN 210 would have ones stored in them.

In one embodiment, each bit in the bitmap 115 corresponds to a particular PSN. That is, the leftmost bit in the bitmap 115 (e.g., the EPSN) can have a first PSN value (EPSN 210), the next bit has a second PSN value (EPSN+1), the next bit has a third PSN value (EPSN+2), and so forth. The zero or one stored in each bit indicates whether the packet with that corresponding PSN has been received. Thus, the bits with a one value indicate the OOO packets. In this manner, the bitmap 115 tracks the OOO packets using their PSNs.

The bitmap 115 also includes a HPSN 215 which corresponds to the OOO packet with the largest PSN. The HPSN 215 can serve as the tail or end of the bitmap 115. When an OOO packet with a larger PSN than the HPSN 215 is received, the RX can update the bitmap 115 so that this new OOO packet becomes the new HPSN 215 of the bitmap 115.

The OOO packet count 120 discussed in FIG. 1 is the total number of OOO packets and can be identified by summing the ones in the bitmap 115. In this case, there are six ones in the bitmap 115, so the OOO packet count would be six.

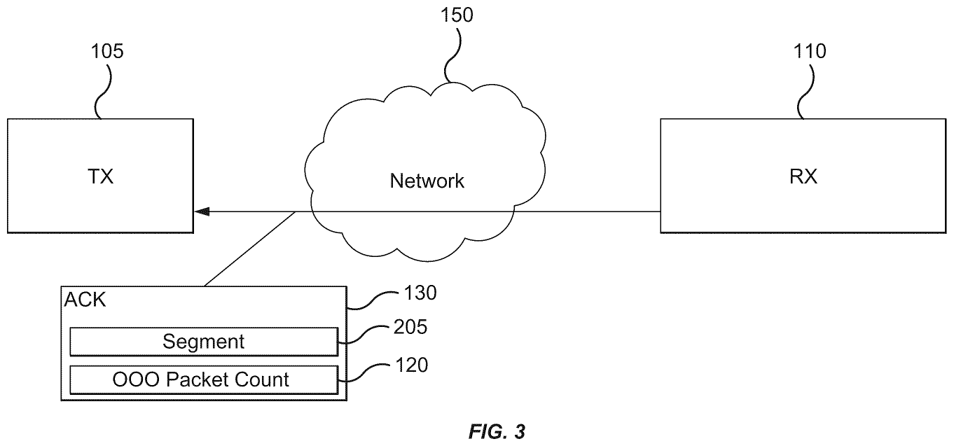

FIG. 3 illustrates transmitting an ACK 130 from the RX 110 to the TX 105, according to an example. In this example, the ACK 130 includes of the segments 205 from the bitmap illustrated in FIG. 2. That is, in the ACK 130 may include only a subportion of the entire bitmap being managed in the RX 110.

Moreover, the ACK 130 includes the OOO packet count 120. In one embodiment, the OOO packet count 120 is a sum of all the OOO packets that have been received at the RX 110, and not just the OOO packets indicated in the segment 205. That is, the OOO packet count 120 can be a count of all the OOO packets in each segment 205 of the bitmap.

In one embodiment, the ACKs 130 are sent to the TX in response to a probe transmitted by the TX to the RX. Further, the RX may not send to the TX any segments of the bitmap that are greater than the HPSN (since those bits would all be zero).

FIG. 4 is a flowchart of a method 400 for detecting packet loss, according to an example. At block 401, a TX transmits packets to a RX using multipathing and according to a congestion window. For example, the congestion window can indicate how many packets the TX can transmit on multiple paths to the RX.

At block 405, a RX tracks OOO packets. In one example, the RX maintains a OOO packet count that indicates the number of OOO packets that have currently been received at the RX. For example, when another OOO packet arrives (e.g., a packet with a PSN higher than the EPSN), the RX increments that OOO packet count. As the next expected packets arrive, packets that were once considered OOO packets may instead be categorized as expected packets. In that case, the RX can decrement the OOO packet count. As such, the OOO packet count can fluctuate up and down as the EPSN and additional OOO packets arrive at the RX.

In addition, the RX can maintain a packet tracking bitmap that has bit values corresponding to a sequence of PSNs to determine which packets have arrived, and which ones have not. The bitmap can be defined by a EPSN and a HPSN as discussed in FIG. 2.

At block 410, the RX transmits an ACK with the current OOO packet count and at least one segment of the bitmap to the TX. Thus, since the TX may not have the entire bitmap (since the ACK only includes a segment), the OOO packet count informs the TX of the total number of OOO packets that have been received across each segment of the bitmap.

At block 415, the TX determines whether the OOO packet count satisfies a threshold. That is, the OOO packet count is compared to a threshold to determine whether the count meets (or exceeds) the threshold.

In one embodiment, the threshold is based on a congestion window used by the TX to transmit packets to the RX. In one embodiment, the threshold can be dynamically set using the following equation:

Threshold=max(retran_config*cwnd, min_config) (1)

In Equation 1, cwnd is the congestion window that is dynamically adjusted by the congestion algorithm in response to network congestion. The retran_config is a value that can be used by a system administrator to increase or decrease the threshold. For example, increasing retran_config from 1 to 2 doubles the threshold. The min_config sets a minimum floor value for the threshold. During congestion, the cwnd may shrink, thereby shrinking the threshold. However, the value of retran_config*cwnd (which is just one example of a metric derived from the congestion window) ever goes below min_config, then the threshold is locked to min_config. This prevents performing retransmission when congestion is high but packet loss may not have occurred.

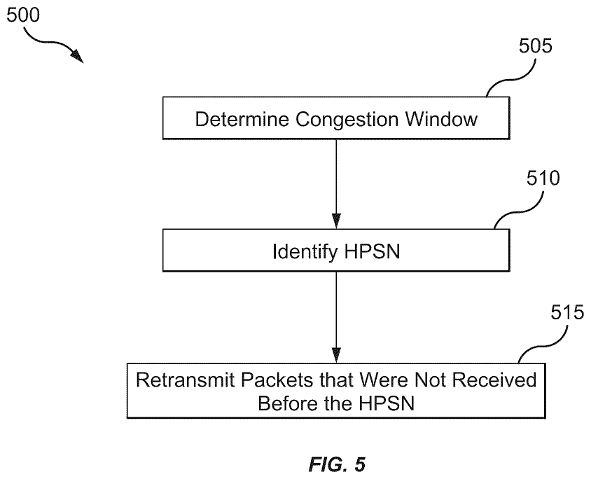

If the OOO packet count received at the TX from an ACK satisfies the threshold, the method 400 proceeds to block 420 where the TX retransmits packets to the RX. This is discussed in more detail in FIG. 5. In contrast, if the OOO packet count does not satisfy the threshold (e.g., is less than the threshold), the method 400 instead proceeds to block 425 where the TX continues to transmit new packets to the RX using multipathing. The method 400 can then repeat by returning to block 405.

FIG. 5 is a flowchart of a method 500 for retransmitting lost packets, according to an example. In one embodiment, the method 500 starts at block 420 of the method 400 where the TX has determined (or inferred) there has been packet loss.

At block 505, the TX determines the current congestion window. The congestion window can be dynamically adjusted using a congestion algorithm. For example, the congestion window may be set based on round trip time or how much data the TX can successfully send to the RX. The embodiments herein are not limited to any particular type of congestion algorithm.

At block 510, the TX identifies the HPSN. This can be provided by the ACKs, which can include the segments 205 of the bitmap 115 shown in FIG. 2. As mentioned above, the HPSN represents the end of the bitmap, since it is the highest or last OOO packet that has been received by the RX.

At block 515, the TX retransmits packets that were not received before the HPSN and subject to the congestion window. In one embodiment, the TX can evaluate the bitmap (since it was sent to the TX from the RX using one or more ACKs) to determine which packets after the EPSN have been received and which have not. Referring to FIG. 2, the TX can identify the bits with zeros and identify their corresponding PSNs. The TX can retransmit the packets with these PSNs to the RX. Moreover, by knowing the HPSN, the TX can decide not to retransmit any packets that have PSNs higher than the HPSN. That is, it may be likely that these packets are still in transit to the RX rather than being lost. As such, the TX may retransmit only the packets that have zero values in the bitmap and are between the EPSN and the HPSN. This may save bandwidth relative to a system where the TX retransmits every packet it has previously sent to the RX after the EPSN.

Moreover, when retransmitting the packets, the TX may be limited by the congestion window. For example, there may be twenty packets between the EPSN and the HPSN that have not yet received by the RX, and thus, should be retransmitted to the RX. If the congestion window indicates the TX can only transmit five unacknowledged packets, the TX may be limited to this window for retransmission.

FIG. 6 illustrates a data processing unit (DPU) which can be the TX or RX discussed above. In one embodiment, the DPU 600 is a programmable processor designed to efficiently handle data-centric workloads such as data transfer, reduction, security, compression, analytics, and encryption, at scale in data centers. The DPU 600 can improve the efficiency and performance of data centers by offloading workloads from a host central processing unit (CPU) or graphic processing units (GPUs). While CPUs and GPUs can specialize on compute, the DPU may specialize in data movement. The DPU 600 can communicate with host CPUs and GPUs to enhance computing power and the handling of complex data workloads.

The DPU 600 includes a plurality of processors 605. In one embodiment, the processors 605 include any number of processing cores. In one embodiment, the processors 605 may be CPUs. The processors 605 can form one or more CPU core complexes. The processors 605 can be any hardware circuitry that uses an instruction set architecture (ISA) to process data, such as a complex instruction set computer (CISC) or reduced instruction set computer (RISC).

The memory 610 can include volatile or non-volatile memory such as random access memory (RAM), high bandwidth memory (HBM), and the like. The memory 610 can include an operating system (OS) 615 that is separate from the host OS.

In one embodiment, the DPU may be in (or be used to implement) a network interface controller/card (NIC) such as a SmartNIC that processes packets before they are forwarded to a host (e.g., a host CPU or GPU). In one embodiment, the DPUs 600 are fully programmable P4 DPUs. The DPU 600 includes multiple pipelines 620 (which can be the same type or different types) for processing received network packets stored in a packet buffer 625. In this example, the pipelines 620 has direct connections to the packet buffer 625.

The pipelines 620 can operate in parallel. Further, the pipelines 620 can be the same type of pipeline (e.g., perform the same tasks). In other embodiments, the DPU 600 may have different types of pipelines 620. For example, the DPU 600 could include networking pipelines which perform networking tasks such as combining packets that were subdivided to be compatible with a maximum transmission unit (MTU) or for dealing with one or more host operating systems, drivers, and/or message descriptor formats in host memory, and could also include direct memory access (DMA) pipelines which perform memory reads and writes.

The pipelines 620 include multiple stages 630 where received packet data is processed at each stage 630 before being passed to the next stage. This packet data could be the entire packet or just a portion of the packet. For example, a parser in the DPU 600, which is upstream from the pipelines 620, may parse out a particular portion of a received packet (e.g., a packet header vector (PHV)) which is then sent to the one of the pipelines 620.

The stages 630 can include circuitry or hardware. In one embodiment, the stages 630 can be programmed using a pipeline programming language, such as P4. In one example, the stages 630 in one pipeline 620 perform the same functions of the stages 630 in another pipeline 620. However, in other embodiments, the stages may perform different functions.

In addition to the stages, the pipelines 620 may each include memory, which can be referred to as local memory. This memory can store local tables that indicate how, or if, a particular packet should be processed at the stages 630. For example, one of the stages in the pipelines 620 can perform a lookup to read a policing entry in a table to determine whether an entity associated with the packet has exceeded a rate limit (e.g., a packet rate limit, a data rate limit, or both).

The DPU 600 can include accelerators 635 to perform specialized tasks associated with data movement. The accelerators 635 can include a cryptography accelerator, a data compression accelerator, as well as accelerators for performing regex or dedupe.

To communicate with the host and a network, the DPU 600 includes host input/output (IO) 640 and network IO 645. The host IO 640 can include a PCIe interface, or any suitable protocol for communicating with a CPU or GPU in the host. The network IO 645 can include Ethernet interfaces, and the like for communicating with a network.

The DPU 600 includes a network on chip (NoC) 650 for interconnecting the various components discussed above. While a NoC is disclosed, the DPU 600 can include any suitable on-chip network. While some components in the DPU 600 may rely on the NoC 650 to communicate with other components, the DPU 600 can also include connections between components that bypass the NoC 650. For example, the packet buffer 625 can have a connection to the network IO 645 that bypasses the NoC 650. Similarly, the pipelines 620 can exchange packet data with the packet buffer 625 without having to rely on the NoC 650. However, to transfer data to the processors 605, the pipelines 620 may use the NoC 650.

In one embodiment, the DPU 600 includes security and management features such as offering a hardware root of trust, secure boot, and the like.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A transmitter, comprising:
circuitry configured to:
transmit packets to a receiver using multipathing and according to a congestion window;
receive at least one acknowledgement (ACK) from the receiver, the ACK comprising an out-of-order (OOO) packet count indicating a number of OOO packets that the receiver has received from the transmitter; and
upon determining the OOO packet count satisfies a threshold, retransmit one or more packets to the receiver, wherein the threshold is dynamically adjusted based on the congestion window.

2. The transmitter of claim 1, wherein the ACK further comprises a subportion of a packet tracking bitmap maintained by the receiver, wherein the packet tracking bitmap comprises bit values corresponding to respective packet sequence numbers (PSNs).

3. The transmitter of claim 2, wherein the bit values indicate whether a corresponding packet transmitted by the transmitter has been received at the receiver, wherein the transmitter is configured to use the bit values to determine which packets should be retransmitted to the receiver and which have already been received by the receiver.

4. The transmitter of claim 3, wherein one of the bit values in the packet tracking bitmap is a highest PSN (HPSN) indicating an OOO packet with the highest PSN, wherein the transmitter does not retransmit any packets that have already been sent to the receiver with PSNs greater than the HPSN.

5. The transmitter of claim 4, wherein one of the bit values in the packet tracking bitmap is an expected PSN (EPSN) indicating a next packet the receiver is expecting to receive from the transmitter, wherein the transmitter only retransmits packets that are between the EPSN and the HPSN and have bit values indicating the transmitted packets have not been received by the receiver.

6. The transmitter of claim 1, wherein the threshold is a maximum of either a metric derived from the congestion window or a minimum floor value.

7. The transmitter of claim 1, wherein the congestion window is reduced when there is more network congestion between the transmitter and the receiver and increased when there is less congestion between the transmitter and the receiver.

8. A method, comprising:
transmitting packets from a transmitter to a receiver using multipathing and according to a congestion window;
receiving at the transmitter at least one acknowledgement (ACK) from the receiver, the ACK comprising an out-of-order (OOO) packet count indicating a number of OOO packets that the receiver has received from the transmitter; and
upon determining the OOO packet count satisfies a threshold, retransmitting one or more packets from the transmitter to the receiver, wherein the threshold is dynamically adjusted based on the congestion window.

9. The method of claim 8, wherein the ACK further comprises a subportion of a packet tracking bitmap maintained by the receiver, wherein the packet tracking bitmap comprises bit values corresponding to respective packet sequence numbers (PSNs).

10. The method of claim 9, wherein the bit values indicate whether a corresponding packet transmitted by the transmitter has been received at the receiver, wherein the method comprises:
using, at the transmitter, the bit values to determine which packets should be retransmitted to the receiver and which have already been received by the receiver.

11. The method of claim 10, wherein one of the bit values in the packet tracking bitmap is a highest PSN (HPSN) indicating an OOO packet with the highest PSN, wherein the transmitter does not retransmit any packets that have already been sent to the receiver with PSNs greater than the HPSN.

12. The method of claim 11, wherein one of the bit values in the packet tracking bitmap is an expected PSN (EPSN) indicating a next packet the receiver is expecting to receive from the transmitter, wherein retransmitting the one or more packets comprises:
only retransmitting packets that are between the EPSN and the HPSN and have bit values indicating the retransmitted packets have not been received by the receiver.

13. The method of claim 8, wherein the threshold is a maximum of either a metric derived from the congestion window or a minimum floor value.

14. The method of claim 8, wherein the congestion window is reduced when there is more network congestion between the transmitter and the receiver and increased when there is less congestion between the transmitter and the receiver.

15. A receiver, comprising:
circuitry configured to:
receive packets from a transmitter using multipathing;
track out-of-order (OOO) packets that are received at the receiver before receiving a next expected packet according to a sequence of packet sequence numbers (PSNs); and
transmit at least one acknowledgement (ACK) to the transmitter, the ACK comprising an OOO packet count indicating a number of OOO packets that the receiver has received from the transmitter.

16. The receiver of claim 15, wherein tracking the OOO packets comprises:
maintaining a packet tracking bitmap at the receiver, wherein each bit value in the bitmap corresponds to a different PSN and indicates whether a packet with that PSN has been received at the receiver.

17. The receiver of claim 16, wherein the ACK further comprises a subportion of the packet tracking bitmap maintained by the receiver.

18. The receiver of claim 16, wherein the transmitter is configured to use the bit values to determine which packets should be retransmitted to the receiver and which have already been received by the receiver.

19. The receiver of claim 18, wherein one of the bit values in the packet tracking bitmap is a highest PSN (HPSN) indicating an OOO packet with the highest PSN, wherein the transmitter does not retransmit any packets that have already been sent to the receiver with PSNs greater than the HPSN.

20. A system comprising:
a receiver; and
a transmitter configured to transmit packets to the receiver, over a network, using multipathing and according to a congestion window,
wherein the receiver is configured to transmit at least one acknowledgement (ACK) to the transmitter, the ACK comprising an out-of-order (OOO) packet count indicating a number of OOO packets that the receiver has received from the transmitter,
wherein the transmitter is configured to, upon determining the OOO packet count satisfies a threshold, retransmit one or more packets to the receiver, wherein the threshold is dynamically adjusted based on the congestion window.
